(19) United States
(12) Patent Application Publication
(10) Pub. No.: US 2026/0311068 A1
(43) Pub. Date: Oct. 8, 2026

(54) ENHANCING ENSEMBLE LEARNING MODELS USING BASE-DELTA CODING

(71) Applicant: QUALCOMM Incorporated, San Diego, CA (US)

(72) Inventor: Mahdi NAZM BOJNORDI, San Diego, CA (US)

(21) Appl. No.: 19/171,706

(22) Filed: Apr. 7, 2025

(51) Int. Cl. G06N 20/20; G06F 18/23

(52) U.S. Cl. CPC G06N 20/20; G06F 18/23

(57) ABSTRACT

Systems and techniques are described for machine learning models. For example, a computing device can determine, for a plurality of expert models of a machine learning model based on a respective plurality of expert weights associated with each of the expert models, a shared base comprising a plurality of base values. The computing device can determine, based on a difference between each expert weight of the respective plurality of expert weights associated with each expert model and the plurality of base values of the shared base, a respective delta map for each expert model of the plurality of expert models. Each delta map including a respective plurality of delta values. The computing device can generate, based on combining the plurality of base values and the respective plurality of delta values associated with each expert model, a respective base-delta representation.

### FIELD

The present disclosure generally relates to machine learning models. For example, aspects of the present disclosure relate to system designs and methods for enhancing ensemble learning models using base-delta coding.

### BACKGROUND

Deep learning machine learning models (e.g., neural networks, such as large language models (LLMs)) can be used to perform a variety of tasks, such as detection and/or recognition of natural language, and natural language processing, among other natural language tasks. Deep learning machine learning models can be versatile and can achieve high quality results in a variety of tasks. However, while deep learning machine learning models can be versatile and accurate, the models can be large and slow, and generally have high memory demands and computational costs. In many cases, the computational complexity of the models can be high, and the models can be difficult to train. In some cases, machine learning models may utilize one or more transformers. Tokens are used by a transformer as its base units for reasoning. For example, a natural language word may be associated with a token, which can be input into the transformer for processing.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for machine learning models. In some aspects, an apparatus for machine-learning processing is provided. The apparatus includes at least one memory and at least one processor coupled to at least one memory and configured to: determine, for a plurality of expert models of a machine learning model based on a respective plurality of expert weights associated with each of the plurality of expert models, a shared base including a plurality of base values; determine, based on a difference between each expert weight of the respective plurality of expert weights associated with each expert model and the plurality of base values of the shared base, a respective delta map for each expert model of the plurality of expert models, each delta map including a respective plurality of delta values; and generate, based on combining the plurality of base values and the respective plurality of delta values associated with each expert model, a respective base-delta representation.

In some aspects, a method for machine-learning processing is provided. The method includes: determining, for a plurality of expert models of a machine learning model based on a respective plurality of expert weights associated with each of the plurality of expert models, a shared base including a plurality of base values; determining, based on a difference between each expert weight of the respective plurality of expert weights associated with each expert model and the plurality of base values of the shared base, a respective delta map for each expert model of the plurality of expert models, each delta map including a respective plurality of delta values; and generating, based on combining the plurality of base values and the respective plurality of delta values associated with each expert model, a respective base-delta representation.

In some aspects, a non-transitory computer-readable medium is provided having stored thereon instructions that, when executed by at least one processor, cause the at least one processor to: determine, for a plurality of expert models of a machine learning model based on a respective plurality of expert weights associated with each of the plurality of expert models, a shared base including a plurality of base values; determine, based on a difference between each expert weight of the respective plurality of expert weights associated with each expert model and the plurality of base values of the shared base, a respective delta map for each expert model of the plurality of expert models, each delta map including a respective plurality of delta values; and generate, based on combining the plurality of base values and the respective plurality of delta values associated with each expert model, a respective base-delta representation.

In some aspects, an apparatus for machine-learning processing is provided. The apparatus includes: means for determining, for a plurality of expert models of a machine learning model based on a respective plurality of expert weights associated with each of the plurality of expert models, a shared base including a plurality of base values; means for determining, based on a difference between each expert weight of the respective plurality of expert weights associated with each expert model and the plurality of base values of the shared base, a respective delta map for each expert model of the plurality of expert models, each delta map including a respective plurality of delta values; and means for generating, based on combining the plurality of base values and the respective plurality of delta values associated with each expert model, a respective base-delta representation.

Some aspects include a device having a processor (or multiple processors) configured to perform one or more operations of any of the methods summarized above. In some cases, the processor(s) can include a neural processing unit (NPU), a neural signal processor (NSP), a digital signal processor (DSP), a graphics processing unit (GPU), a central processing unit (CPU), any combination thereof, and/or other processor(s). Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating a comparison between an example dense model and an example sparse model, in accordance with some aspects of the disclosure.

FIG. 2 is a diagram illustrating an example of MOE token choice routing, in accordance with some aspects of the disclosure.

FIG. 3 is a diagram illustrating an example of a MOE model including a shared expert model and routing expert models, in accordance with some aspects of the disclosure.

FIG. 4 is a diagram illustrating an example of base-delta representations for a plurality of experts models (e.g., routing expert models) of a machine learning model, in accordance with some aspects of the disclosure.

FIG. 5 is a diagram illustrating a comparison between an example of existing representations for expert models (e.g., routing expert models) and an example of base-delta representations for expert models (e.g., routing expert models), in accordance with some aspects of the disclosure.

FIG. 6 is a table illustrating an example of a plurality of potential candidate expert model groupings to use for a machine-learning model, in accordance with some aspects of the disclosure.

FIG. 7 is a diagram illustrating tables showing an example of clustering expert models into clusters, in accordance with some aspects of the disclosure.

FIG. 8 is a diagram illustrating tables showing an example of adjusting base values according to bit widths for the delta values, in accordance with some aspects of the disclosure.

FIG. 9 is a diagram illustrating tables showing a continuation of the example of FIG. 8 of adjusting base values according to bit widths for the delta values, in accordance with some aspects of the disclosure.

FIG. 10 is a diagram illustrating tables showing an example of selecting a candidate expert model grouping from a plurality of candidate expert model groupings, based on representation errors for the plurality of the candidate expert model groupings, in accordance with some aspects of the disclosure.

FIG. 11 is a block diagram of an example transformer, in accordance with some aspects of the disclosure.

FIG. 12 is a flow diagram illustrating an example of a process for enhancing ensemble learning models using base-delta coding, in accordance with some aspects of the disclosure.

FIG. 13 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, deep learning machine learning models (e.g., neural networks, such as large language models (LLMs)) can be used to perform a variety of tasks, such as natural language processing (e.g., detection, recognition, generation, etc. of natural language), vision processing (e.g., image and/or video processing), among other tasks. Deep learning machine learning models can be versatile and can achieve high quality results in a variety of tasks. While deep learning machine learning models can be versatile and accurate, the models can be large and slow. For example, deep learning machine learning models typically have high memory demands and computational complexity/costs, which can make such models difficult to train.

In some cases, machine learning models may include one or more transformer models. Tokens can be utilized by a transformer model as its base unit for reasoning. For example, a natural language word can be associated with a token, which can be input into the transformer for processing. A transformer model improves language processing with its unique architecture. The transformer architecture has two main non-embedding components, including an attention component and a feedforward network (FFN). For example, the attention component captures interdependencies between words (e.g., natural language words), while the FFN non-linearly transforms each input token (e.g., each associated with a word) independently.

The FFN enhances the capability of the transformer to handle diverse and complex linguistic tasks with efficiency and effectiveness. The FFN includes two linear fully connected layers (e.g., a multi-layer perceptron (MLP)) that transform the input data. Positioned within both the encoder and decoder modules of the transformer, the FFN refines data processed by the attention mechanisms of the transformer. By systematically refining the output from the attention layers of the transformer, the FFN helps to maintain high performance of the transformer across different natural language processing applications.

The capacity of a machine learning model (e.g., a neural network) to absorb information is limited by the number of parameters of the model. As a consequence, finding more effective ways to increase model parameters has become a trend in deep learning research. Mixture of Experts (MOEs) is a type of conditional computation where parts of the network are activated on a per-example basis. MOEs can be used as a way to dramatically increase model capacity without a proportional increase in computation. For example, in sparsely activated variants of MOE models, a subset of experts is selected on a per-token (or per-example) basis, which creates sparsity in the network. Such models have demonstrated better scaling in multiple domains and better retention capability in a continual learning setting.

MOEs operate by adopting a number of experts (e.g., with each expert being a sub-network) and activating one or more experts for each input token. A gating network (e.g., a router or routing network) can be optimized to route each token to the most suited expert(s) for a given token. Depending upon how tokens are mapped to experts, MOEs can be sparse or dense. Sparse MOEs only select a subset of experts when routing each token, which reduces computational cost as compared to dense MOEs.

LLMs improve machine intelligence by enabling a wide range of processing tasks, such as natural language processing tasks, vision processing tasks, etc. However, deploying LLMs on some devices (e.g., mobile devices) presents a challenge due to the large number of LLM parameters and significant memory and compute costs of LLMs. The use of MOEs can significantly increase the number of parameters in a machine learning model (e.g., an LLM) without a proportional increase in computation during training and inference. Such computational efficiency can be achieved by selectively activating (e.g., as in a sparse model) only a subset of parameters (or experts) for each input. MOEs for LLMs can be designed by replacing an FFN layer in a transformer block with a set of expert FFN layers. As noted above, an MOE model can include a gating/routing mechanism (e.g., a router or routing network) that dynamically determines which expert (or combination of experts) is best suited for a given input during inference.

Experts within MOE models typically share the same architecture, but have different weights. One or more experts are typically deployed to generate tokens. However, the experts can be large in size and the token generation can become memory bound. MOEs demand increasingly high bandwidth and memory.

MOEs may be of an excessive size. For example, the size of MOE models can be excessive because the size can easily exceed the capacity of a typical dynamic random-access memory (DRAM). As such, specialized hardware or distributed systems may be required to handle the MOEs efficiently. For example, a switch transformer can have over 1.6 trillion parameters. However, the compute resources required to train the switch transformer can be approximately equal to that of a ten billion-parameter dense model. For another example, generative pre-trained transformer-4 (GPT-4) is composed of eight expert models, where each expert model include 220 billion parameters, which has a total 1.76 trillion parameters.

MOEs can have a high demand for memory bandwidth. For example, each token may require different experts, which can lead to frequent and unpredictable memory access patterns. The need to transfer data between memory and processing units for different experts can increase memory bandwidth demands. The dynamic nature of expert selection can lead to poor cache hit rates, further straining the memory bandwidth. As the number of experts increases, the memory bandwidth requirements grow, making it challenging to scale MOE models efficiently. As such, improved systems and techniques for MOEs that have an excessive size and/or require a significant amount of bandwidth can be beneficial.

In one or more aspects of the present disclosure, systems, apparatuses, methods (also referred to as processes), and computer-readable media (collectively referred to herein as “systems and techniques”) are described herein that provide solutions for enhancing ensemble learning models using base-delta coding.

Various aspects relate generally to machine learning models. Some aspects more specifically relate to systems and techniques that provide solutions that provide a mechanism that is versatile and can be implemented across various mobile devices, laptops, and servers that utilize ensemble learning models, such as MOEs. The systems and techniques are particularly beneficial for large models that require significant bandwidth and/or cannot fit within the system memory, by offering substantial performance improvements.

The systems and techniques provide a base-delta representation (e.g., a base-delta coding) for the experts' weights that aims to reduce the size of the ensemble-based AI models, thereby improving energy efficiency and performance. This representation can reduce the data transfer bandwidth for large MOE models by using lower bit-widths for the expert values. The delta can include a plurality of delta values, and the base can include a plurality of base values. The delta is smaller in size than the expert and base and, as such, the delta consumes less memory bandwidth. Overall, the technique provides a tradeoff between memory bandwidth versus a re-computation of the weights.

The mechanism relies solely on a post-training process, which eliminates the need for retraining. The systems and techniques are applicable to a wide range of machine learning processors (e.g., central processing unit (CPU), graphics processing unit (GPU), tensor processing unit (TPU), network signal processor (NSP), etc.) that implement ensemble-based models.

As mentioned, large ensemble-based models (e.g., MOEs) can encounter size and bandwidth issues. A more aggressive quantization is a possible alternative solution to these issues. However, an aggressive quantization can result in a significant loss in accuracy per quantized value.

In one or more aspects, during operation of a method for machine-learning processing, one or more processors can determine, for a plurality of expert models of a machine learning model based on a respective plurality of expert weights associated with each of the expert models, a shared base including a plurality of base values. The one or more processors can determine, based on a difference between each expert weight of the respective plurality of expert weights associated with each expert model and the plurality of base values of the shared base, a respective delta map for each expert model of the plurality of expert models, each delta map including a respective plurality of delta values. The one or more processors can generate, based on combining the plurality of base values and each respective plurality of delta values associated with each expert model, a respective base-delta representation.

In one or more examples, determining the shared base can be further based on clustering the plurality of expert models into a plurality of clusters, where each cluster of the plurality of clusters can include a respective portion of expert models of the plurality of expert models. In some examples, the clustering can be performed based on a k-means clustering. In one or more examples, the one or more processors can clamp, based on a clamping threshold value, the respective plurality of delta values of the respective delta maps.

In some examples, the one or more processors can generate, based on a bit width for each delta value of the respective plurality of delta values, a list of a plurality of candidate expert model groupings comprising the plurality of expert models. In one or more examples, the one or more processors can select, based on a respective representation error associated with each of the candidate expert model groupings, a candidate expert model grouping of the candidate expert model groupings for the machine-learning processing. In one or more examples, each respective representation error of the respective representation errors associated with each of the candidate expert model groupings can be a mean absolute error (MAE).

In one or more examples, the one or more processors can generate, based on training the machine learning model, the respective plurality of weights associated with each expert model of the plurality of expert models. In some examples, the machine learning model can be an ensemble learning model.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As previously mentioned, deep learning machine learning models, such as LLMs, may be employed to perform a variety of tasks (e.g., detection and/or recognition of natural language, and natural language processing, among other natural language tasks). Deep learning machine learning models are versatile and may achieve high-quality accurate results in a variety of tasks. However, deep learning models can be large and slow and can have large memory and computational costs. The computational complexity of deep learning models can be high, and deep learning models can be difficult to train. In one or more cases, machine learning models can employ one or more transformers. Tokens can be used by a transformer as its base units for reasoning. For example, a natural language word can be associated with a token, which can be input into the transformer for processing.

Advances in machine learning, especially in natural language, have been achieved by increasing the computational budget, training data, and model size. Training state-of-the-art models, however, requires thousands of specialized, interconnected accelerators for weeks or months at a time. The models are therefore expensive to produce and incur high energy costs. As the scale of machine learning systems has increased, more efficient training and serving paradigms have been sought, such as sparse models.

LLMs enable a wide range of natural language processing tasks. However, deploying LLMs on mobile devices presents challenges due to their enormous parameter sizes, and significant memory and compute costs. Using MOEs (e.g., for LLMs or other types of machine learning models) can increase the number of parameters in a model (e.g., an LLM) without a proportional increase in computation during training and inference. For example, computational efficiency can be achieved by selectively activating (e.g., as in a sparse model) only a subset of parameters (or experts) for each input. Although MOEs (e.g., in a sparse model) provide computational benefits, as compared to dense models, MOEs have several challenges for training and on-device inference.

Currently, sparse expert models are a popular architecture in deep learning. The sparse expert model class of architecture encompasses MOEs. An MOE layer in an MOE architecture can include a set of experts, a routing mechanism (e.g., a routing network), and an optional loss function to balance the assignment of tokens to experts. For example, an MOE for an LLM may be designed by replacing an FFN layer in a transformer block with a set of expert FFN layers. The MOE model can include a gating/routing mechanism (e.g., a router or routing network) that dynamically determines which expert (or combination of experts) is best suited for a given input during inference. A switch transformer is a variant of an MOE layer using top-1 routing instead of top-k routing (where k≥2). Using a sparse expert model, the degree of sparsity decouples the parameter count from a compute per example allowing for extremely large, but efficient models. The resulting models have demonstrated significant improvements across diverse domains, such as natural language processing, computer vision, and speech recognition.

Sparse expert models, such as MOEs, are neural networks where a set of the parameters are partitioned into “experts”, each with a unique weight. During training and inference, the models route input examples to specific expert(s) weights. As a result, each example only interacts with a subset of the network parameters, converse to the usual approach, where the entire network is used for each input. Because only a fraction of the experts are used for each example, the amount of computation may remain small relative to the total model size.

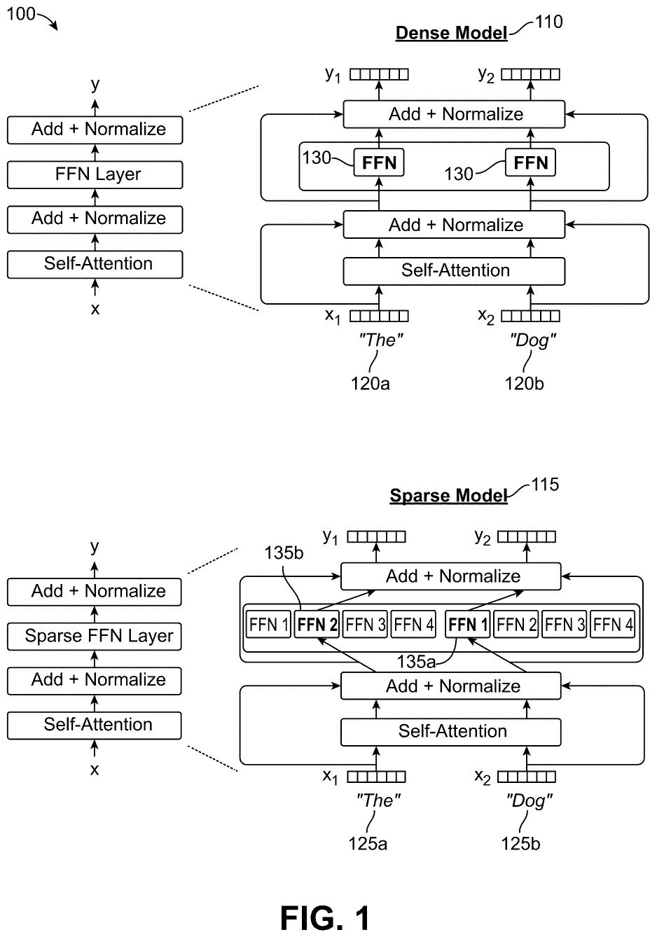

FIG. 1 is a diagram illustrating a comparison 100 between an example dense model 110 (e.g., in the form of a dense expert transformer) and an example sparse model 115 (e.g., in the form of a sparse expert transformer). In FIG. 1, tokens 120a, 120b, 125a, 125b can be used by the dense model 110 and the sparse model 115 as base units for reasoning. For example, a natural language word (e.g., “the” or “dog”) can be associated with a token 120a, 120b, 125a, 125b, which can be input into the dense model 110 and the sparse model 115 for processing.

In FIG. 1, the dense model 110 is shown to send both input tokens 120a, 120b (e.g., associated with the natural language words “the” and “dog”, respectively) to the same FFNs 130. Conversely, the sparse model 115 is shown to route each input token 125a, 125b (e.g., associated with the natural language words “the” and “dog”, respectively) independently amongst four experts (e.g., FFN 1 135a, FFN 2 135b, FFN 3, FFN 4). For example, in FIG. 1, the sparse model 115 is shown to route token 125a (e.g., associated with the natural language word “the”) to FFN 2 135b, and the sparse model 115 is shown to route token 125b (e.g., associated with the natural language word “dog”) to FFN 1 135a. In FIG. 1, each transformer (e.g., each of the dense model 110 and the model 115) uses a similar amount of computation, but the sparse model 115 has more unique parameters (e.g., experts) than the dense model 110.

As previously mentioned, the capacity of a neural network to absorb information is limited by the number of its parameters, and as a consequence, finding more effective ways to increase model parameters has become a trend in deep learning research. MOE (e.g., a type of conditional computation where parts of the network are activated on a per-example basis) has been used to dramatically increase model capacity without a proportional increase in computation. In sparsely activated variants of MOE models (e.g., the sparse model 115 in FIG. 1), a subset of experts is selected on a per-token (or per-example) basis, which creates sparsity in the network. Such models have demonstrated better scaling in multiple domains, and better retention capability in a continual learning setting.

MOEs (e.g., a sparse model) enable models to be pretrained with far less compute, which means that the model or dataset size can be dramatically scaled up with the same compute budget as a dense model. In particular, an MOE model should achieve the same quality as its dense counterpart much faster during pretraining. In the context of transformer models, MOEs include two main elements, including sparse MOE layers and a gate network or router. The terms “gate network” and “router” may be used interchangeably and/or may otherwise be used synonymously throughout various aspects described herein. The sparse MOE layers are used instead of dense FFN layers. MOE layers have a certain number of experts (e.g., eight experts), where each expert is a neural network. In practice, the experts are FFNs, but they can also be more complex networks or even an MOE itself.

MOEs operate by adopting a number of experts, each as a sub-network, and activating only one (or a few experts) for each input token. A gating network (e.g., a router or routing network) may be chosen and optimized in order to route each token to the most suited expert(s). Sparse MOEs (e.g., a sparse model) only select a subset of experts when routing each token, which reduces computational cost as compared to dense MOEs (e.g., a dense model).

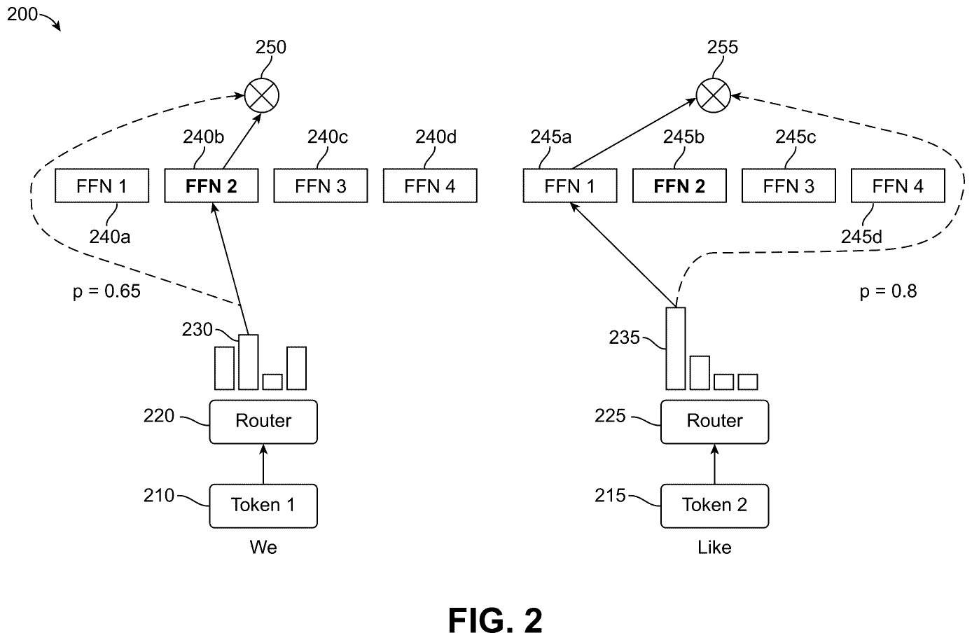

A gate network or router determines which tokens are sent to which expert(s). FIG. 2 shows an example of routers 220, 225 routing respective tokens 210, 215 to particular experts (e.g., FFN 2 240b and FFN 1 245a). In particular, FIG. 2 is a diagram illustrating an example of MOE token choice routing. In FIG. 2, a sparse switch FFN layer 200 is shown. A sparse MOE layer may employ the sparse switch FFN layer 200 of FIG. 2.

The sparse switch FFN layer 200 operates independently on the tokens 210, 215 in a sequence. The tokens 210, 215 are each associated with a natural language word. For example, token 210 is shown to be associated with the natural language word “we”, and token 215 is shown to be associated with the natural language word “like”.

In FIG. 2, the two tokens 210, 215 are shown to be routed across four FFN experts (e.g., among FFN 1 245a, FFN 2 245b, FFN 3 245c, and FFN 4 245d; and among FFN 1 245a, FFN 2 245b, FFN 3 245c, and FFN 4 245d), where each router 220, 225 independently routes each token 210, 215, respectively, based on a routing algorithm. The routing algorithm routes the tokens 210, 215 to maximize token-expert affinities. In one or more examples, the routing algorithm employs a token choice strategy (e.g., a top-k token routing strategy), where the routing algorithm selects the most suitable one (e.g., a top-one selection), two (e.g., a top-two selection), or several experts to route to for each token. For example, the routing algorithm can choose the top-one or top-two experts with the highest affinity scores (e.g., highest probability (p)) for each token. The affinity scores can be trained together with the model parameters. In one or more examples, the affinity scores (e.g., probabilities) can be passed through a Softmax algorithm such that the affinity scores (e.g., probabilities), when summed together, are equal to one (1.0).

In FIG. 2, the router 220 routes (e.g., sends) token 1 210 to the second expert (e.g., FFN 2 240b) of a plurality of experts (e.g., FFN 1 240a, FFN 2 240b, FFN 3 240c, and FFN 4 240d), based on the router gate value 230 with a probability p equal to 0.65. The remaining experts (e.g., FFN 1 240a, FFN 3 240c, and FFN 4 240d) do not perform any processing. The router 225 routes (e.g., sends) the token 2 215 to the first expert (e.g., FFN 1 245a) of a plurality of experts (e.g., FFN 1 245a, FFN 2 245b, FFN 3 245c, and FFN 4 245d), based on the router gate value 235 with a probability p equal to 0.8. The remaining experts (e.g., FFN 2 245b, FFN 3 245c, and FFN 4 245d) do not perform any processing.

The sparse switch FFN layer 200 then returns the output of the selected FFN expert multiplied by a router gate value. The sparse switch FFN layer 200 illustrates an example of top-1 routing. For example, the sparse switch FFN layer 200 returns the output of the selected FFN expert (e.g., FFN 2 240b) multiplied (e.g., by multiplier 250) by the router gate value 230 with a probability p equal to 0.65. The sparse switch FFN layer 200 returns the output of the selected FFN expert (e.g., FFN 1 245a) multiplied (e.g., by multiplier 255) by the router gate value 235 with a probability p equal to 0.8.

MOE is an ensemble learning technique used in neural networks that relies on several concepts to improve efficiency and performance. These concepts can include a division of tasks, expert models, a gating model, and combining predictions. The concept of the division of tasks involves the main problem (e.g., within a prompt) being divided into smaller sub-tasks. The concept of expert models can involve each sub-task being handled by a specialized model, which is known as an “expert model” or simply as an “expert.” The concept of a gating model can involve a gating model (e.g., a router) that can determine which expert model(s) of a plurality of expert models to use for each input based on the characteristics of the expert models. The concept of combining predictions can involve the outputs from the selected expert models being combined to produce a final prediction.

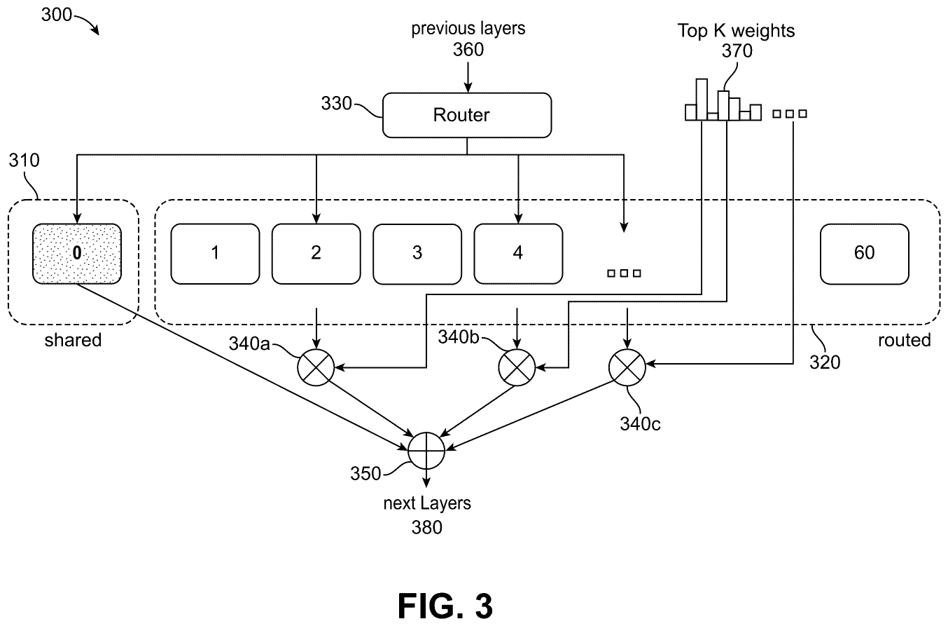

FIG. 3 shows an example of an MOE model including a plurality of expert models. In particular, FIG. 3 is a diagram illustrating an example of a MOE model 300 including one shared expert model 310 and a plurality of routing expert models 320. In FIG. 3, the MOE model 300 is shown to include a router 330, multipliers 340a, 340b, 340c, a summer 350, and a plurality of expert models, including the one shared expert model 310 (e.g., shared expert model 0) and the plurality of routing expert models 320 (e.g., routing expert models 1 through 60).

In practice, each expert model is an FFN with matrix operations being its key computation. Typically, one shared expert model 310 and multiple routed expert models 320 are employed. For each token, the router 330 can, based on information (e.g., weights) from previous layers 360, select expert models (e.g., shared expert model 0, routing expert model 2, routing expert model 4, and routing expert model X) from the plurality of expert models.

The selected expert models are weighted with coefficients generated at runtime. The weights of the selected expert models can be multiplied, by the multipliers 340a, 340b, 340c, with top weights 370 to generate resultant weights. The resultant weights can be combined (e.g., summed), by the summer 350, to produce final weights (e.g., a final prediction), which are passed on to the next layers 380.

All routed expert models 320 have the same architecture, size, and topology. The only difference amongst the expert models is their weight values. Each expert model has a different set of weights. For large models, the size of the expert models can easily exceed the DRAM capacity. Therefore, improved systems and techniques for MOEs that have an excessive size and/or require a significant amount of bandwidth can be useful.

In one or more aspects, the systems and techniques provide solutions for enhancing ensemble learning models using base-delta coding. In one or more examples, the systems and techniques provide a base-delta representation (e.g., a base-delta coding) for the experts' weights that aims to reduce the size of the ensemble-based AI models, thereby improving energy efficiency and performance. This representation can reduce the data transfer bandwidth for large MOE models by using lower bit-widths for the expert values. The delta can consist of a plurality of delta values, and the base can consist of a plurality of base values. The delta can be smaller in size than the expert and base and, thus, the delta can consume less memory bandwidth.

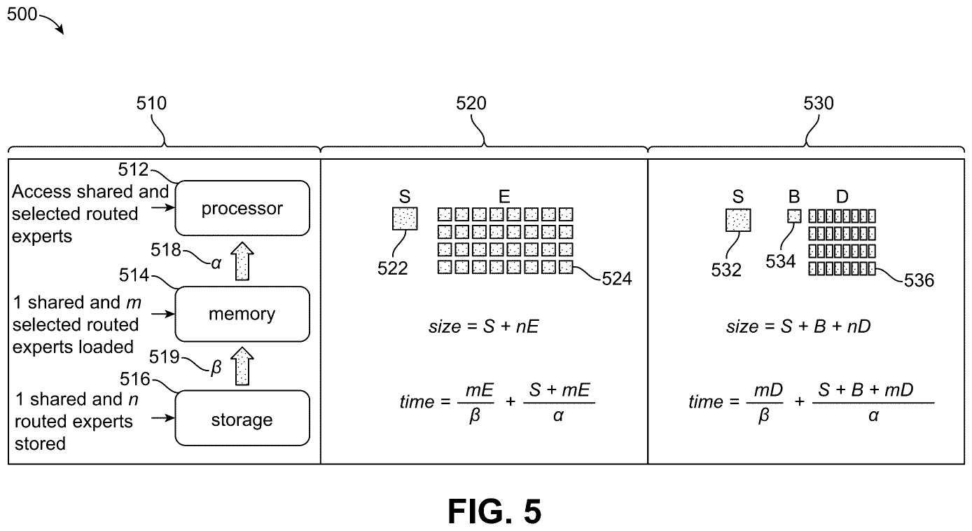

As mentioned, the expert model sizes can be reduced by employing base-delta representations for the expert models. In one or more examples, each expert model (e.g., routing expert model, such as routing expert models 320 of FIG. 3) can be represented using a base-delta pair. For example, the expert models (E) can be represented by a shared based (B) and multiple delta maps (D), leveraging the same neural topology and number of parameters (e.g., weights). This mechanism can be specifically applied to weights of MOEs. The weights can be processed offline into the base-delta representations without the need for retraining. During inference, the values (e.g., weights) of the base-delta representations can be read in from memory (e.g., memory 514 of FIG. 5) and combined at the processor core (e.g., processor 512 of FIG. 5) before the computation.

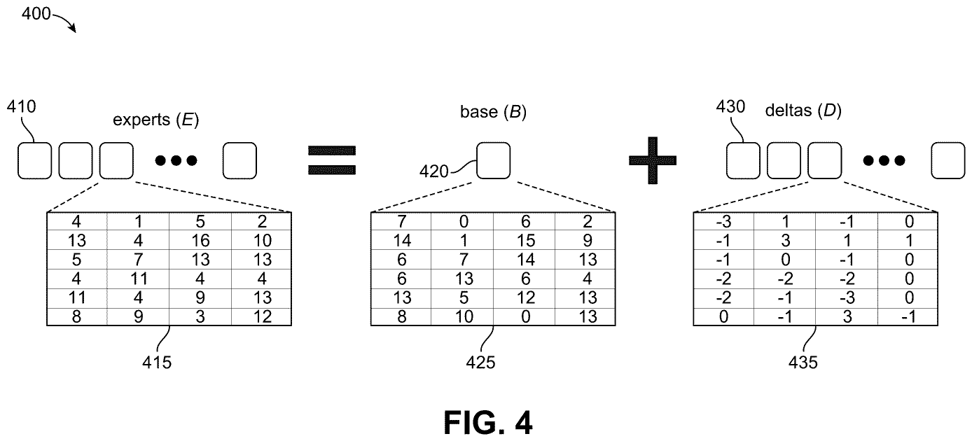

FIG. 4 shows an example of base-delta representations for expert models. In particular, FIG. 4 is a diagram illustrating an example of base-delta representations 400 for a plurality of expert models (e.g., routing expert models) of a machine learning model. In FIG. 4, a plurality of expert models (E) 410 (e.g., routing expert models, such as the routing expert models 320 of FIG. 3), a shared base (B) 420, and a plurality of delta maps (D) 430 are shown. Each expert model (E) 410 of the plurality of expert models (E) 410 can be associated with a respective plurality of expert weights 415. The shared base (B) 420 can be associated with a plurality of base values 425. Each delta map (D) 430 of the plurality of delta maps (D) 430 can be associated with a respective plurality of delta values 435.

In one or more examples, during operation of a method for generating base-delta representations for expert models (E) 410 (e.g., routing expert models) of a machine learning model, one or more processors can generate, based on training the machine learning model, a respective plurality of weights 415 associated with each expert model (E) 410 of the plurality of expert models (E) 410. In one or more examples, the machine learning model can be an ensemble learning model.

The one or more processers can determine, for the plurality of expert models (E) 410 of the machine learning model based on the respective plurality of expert weights 415 associated with each of the expert models (E) 410, a shared base (B) 420 including a plurality of base values 425. The one or more processors can determine, based on a difference between each expert weight 415 of the respective plurality of expert weights 415 associated with each expert model (E) 410 and the plurality of base values 425 of the shared base (B) 420, a respective delta map (D) 430 for each expert model (E) 410 of the plurality of expert models (E) 410, each delta map (D) 430 including a respective plurality of delta values 435. The one or more processors can generate, based on combining (e.g., summing) the plurality of base values 425 and each respective plurality of delta values 435 associated with each expert model (E) 410, a respective base-delta representation. For example, as shown in FIG. 4, an expert weight 415 of 4 (e.g., located at row 1, column 1) can be represented by a base-delta representation, which can be generated by summing the base value 425 of 7 (e.g., located at row 1, column 1) with the delta value 435 of −3 (e.g., located at row 1, column 1).

In one or more aspects, significant size reductions and speedups are possible by employing base-delta representations for the expert models. The goal of the base-delta representations is to reduce the size of the expert models. The delta maps can be computed in a way such that they require significantly fewer bits than the original expert models. Ideally, the aggregate size of a base-delta pair should not exceed the size of the original expert model. In one or more examples, data size reduction can be achievable when multiple expert models share the same base. Higher performance can be achievable by reducing the data transfer. In one or more examples, the bandwidth demand and the amount of transferred data can be significantly reduced.

FIG. 5 shows a example comparison between existing representations for expert models and base-delta representations for expert models. In particular, FIG. 5 is a diagram illustrating a comparison 500 between an example of existing representations for expert models (e.g., routing expert models) and an example of base-delta representations for expert models (e.g., routing expert models). FIG. 5 is shown to include an example of a machine learning system 510, an example of existing representations for expert models 520, and an example of base-delta representations for expert models 530.

In FIG. 5, the system 510 is shown to include a processor 512, memory 514 (e.g., DRAM), and storage 516. The system 510 can be assumed to be a generic system with a memory bandwidth (α) 518 for data transfer and a storage bandwidth (β) 519 for data transfer.

In FIG. 5, the expert models (e.g., one shared expert model and n number of routed expert models) can be stored within the storage 516. In one or more examples, the one shared expert model may be stored in the memory 514. There is a limited amount of memory bandwidth (α) 518 and storage bandwidth (β) 519 for data transfer.

A portion of the expert models (e.g., the one shared expert model and m number of selected routing expert models, where m is less than n) can be transferred from the storage 516 to the memory 514. The portion of the expert models (e.g., the one shared expert model and the m number of selected routing expert models) can be transferred from the memory 514 to the processor 512 for processing.

The example of existing representations for expert models 520 of FIG. 5 shows a representation of the one shared expert model 522 and the plurality of routing expert models 524. Equations for the size(S) of the representation and the time (time) for transferring these expert models.

The example of base-delta representations for expert models 530 of FIG. 5 shows a representation of the one shared expert model 532 and the base-delta representations for the routing expert models 524. The base-delta representations are shown to include a shared base 534 and a plurality of delta maps 536. As depicted in FIG. 5, the plurality of delta maps 536 are of a smaller size (e.g., have smaller bit-widths) than the routing expert models 524. Equations for the size(S) of the representation and the time (time) for transferring the shared expert model 532 and the base-delta representations are also shown.

In one or more aspects, an expert model can be represented using an arithmetic means of the expert models and their differences. The goal is to minimize the delta maps with using a few means of the expert models.

In one or more examples, during operation for representing an expert model, one or more processors can create (e.g., generate) a listing including a plurality of candidate expert groupings. Each candidate expert grouping can be represented as a (k, d) pair, where k can represent the number of base expert models, and d is the bit width for representing each delta value. Only expert models that meet user-defined requirements (e.g., bit width, model size, memory bandwidth, etc.) shall be included in the listing.

In one or more examples, to create the listing of candidate expert groupings, one or more processors can explore potential (k, d) pairs based on user-defined requirements. In one or more examples, several parameters can be considered for evaluating various different representations. These parameters can include two user-defined parameters, which are potential bandwidth savings (γ) and approximation error (ε). The number of selected experts (m) and the base bit width (b) can be used, by the one or more processors, to explore potential candidate expert groupings. In one or more examples, potential (k, d) pairs can be those that satisfy the following formula:

$$\frac{md + kb}{mb} \leq γ$$

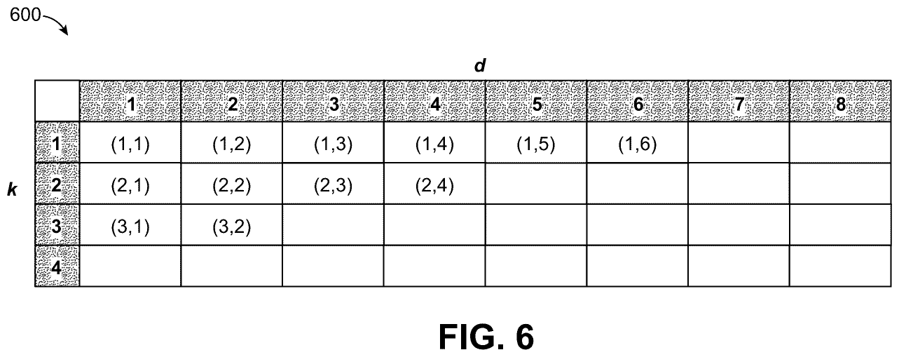

For an example, it can be assumed that m=4, b=8, and γ=1. FIG. 6 shows the candidate expert groupings for the listing, when applying these assumed values to the formula. In particular, FIG. 6 is a table 600 illustrating an example of a plurality of potential candidate expert model groupings to use for a machine-learning model. In particular, the table 600 shows a total of twelve candidate expert model groupings, where each candidate expert model grouping is represented as a (k, d) pair.

In one or more examples, after the listing has been created, the one or more processors can evaluate each (k, d) pair in the listing. For an example, only an evaluation of one of the twelve candidate expert model groupings (e.g., the candidate expert model grouping associated with the (2, 3) pair) will be described. In one or more examples, the (2, 3) pair may have eight expert models (e.g., E-0 to E-7), each with 32 values.

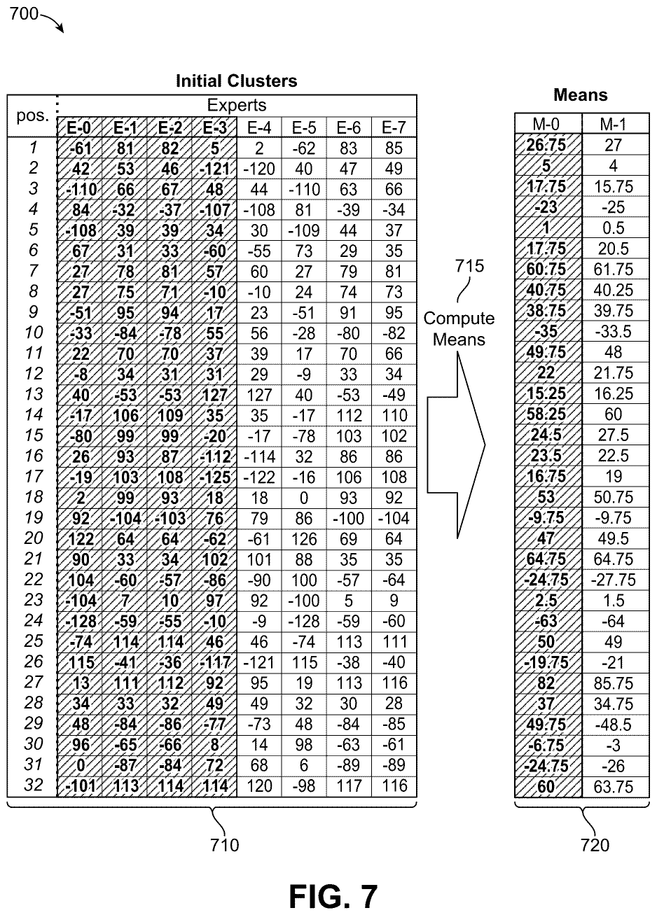

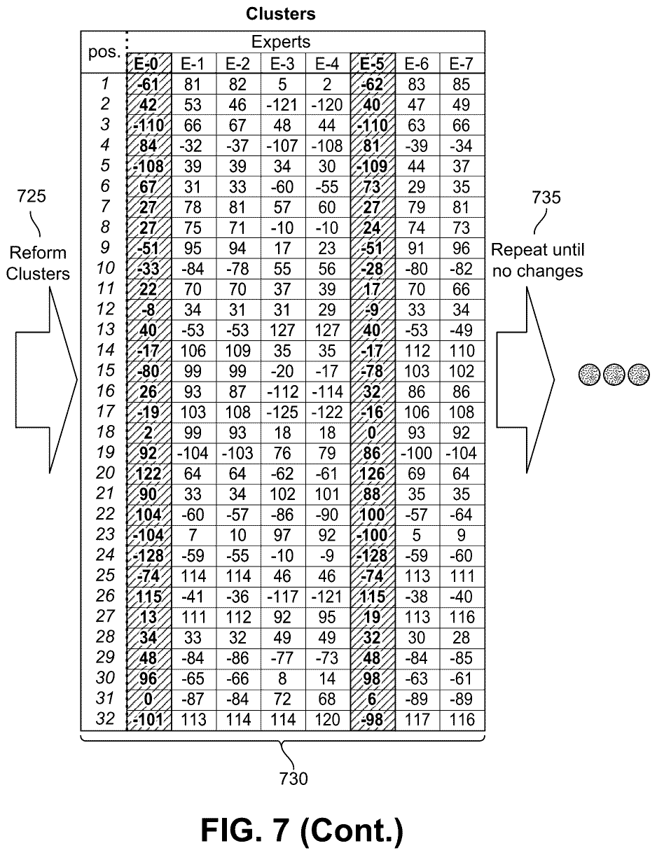

For the evaluation of the (2, 3) pair, the one or more processors may perform clustering (e.g., based on using a standard clustering algorithm) of the expert models into a plurality of clusters. In one or more examples, the clustering may be based on a k-means clustering. In some examples, the clustering may be performed randomly. FIG. 7 shows an example 700 of clustering of the expert models of the (2, 3) pair. In particular, FIG. 7 is a diagram illustrating tables 710, 720, 730 showing an example of clustering expert models into clusters. In FIG. 7, the table 710 (e.g., an initial clusters table) shows initial clusters (e.g., two clusters) formed for the expert models, where a first cluster includes expert models E-0 to E-3 and a second cluster includes expert models E-4 to E-7. The table 710 includes the weights for the expert models.

After the initial clusters have been formed. The one or more processors can compute the means 715 for each of the clusters. The table 720 (e.g., a means table) shows the computed means for the clusters. For example, the means of the values (e.g., −61, 81, 82, 5) in the first row of the table 710 for the first cluster of expert models can be computed to be equal to 26.75, which is shown in the first row, first column of table 720. In one or more examples, the values for the expert models in the clusters (as shown in table 710) may be quantized values (e.g., integers), and the values for the means (as shown in table 720) may be floating point numbers.

After the means have been computed, the one or more processors can reform the clusters 725. The one or more processors can reform the clusters by clustering the expert models into a plurality of different clusters. In FIG. 7, table 730 (e.g., a clusters table) shows clusters (e.g., two clusters) formed for the expert models, where a first cluster includes expert models E-0 and E-5 and a second cluster includes expert models E-1 to E-4, E-6, and E-7. The one or more processors can then repeat (e.g., the clustering and computing of the means as described) until no changes 735 continue to occur.

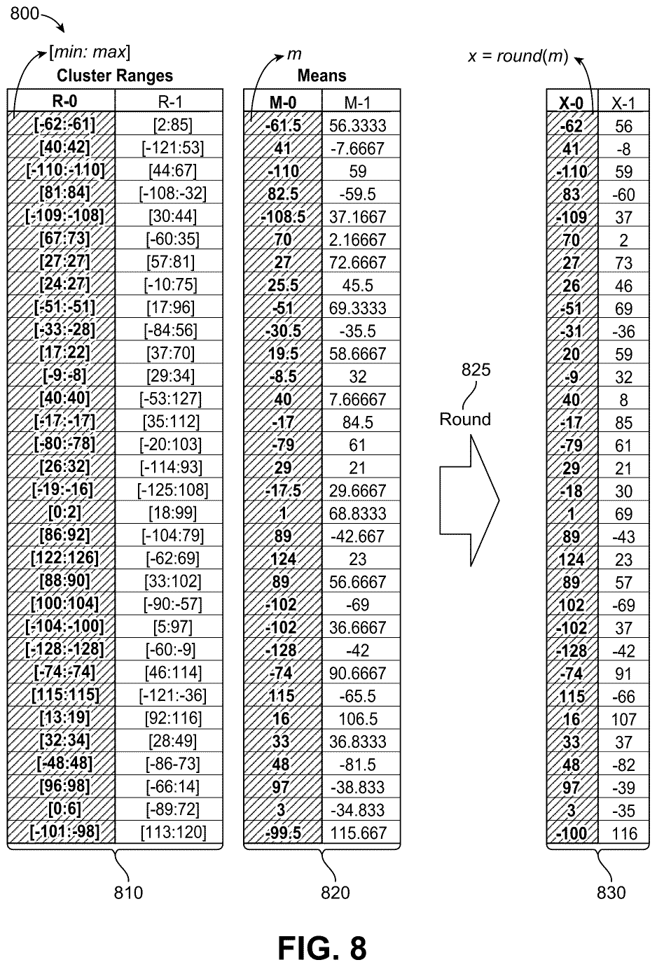

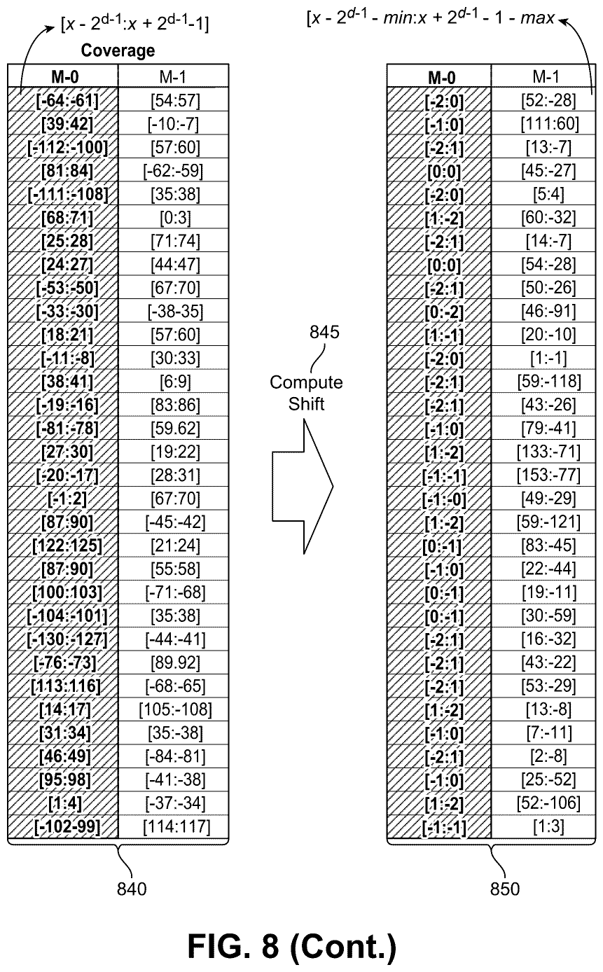

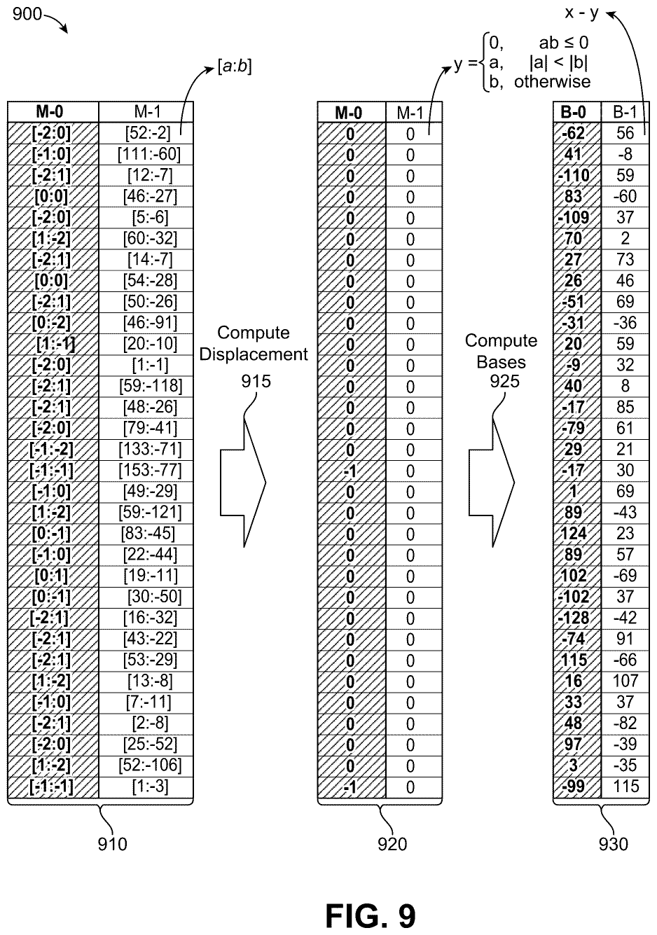

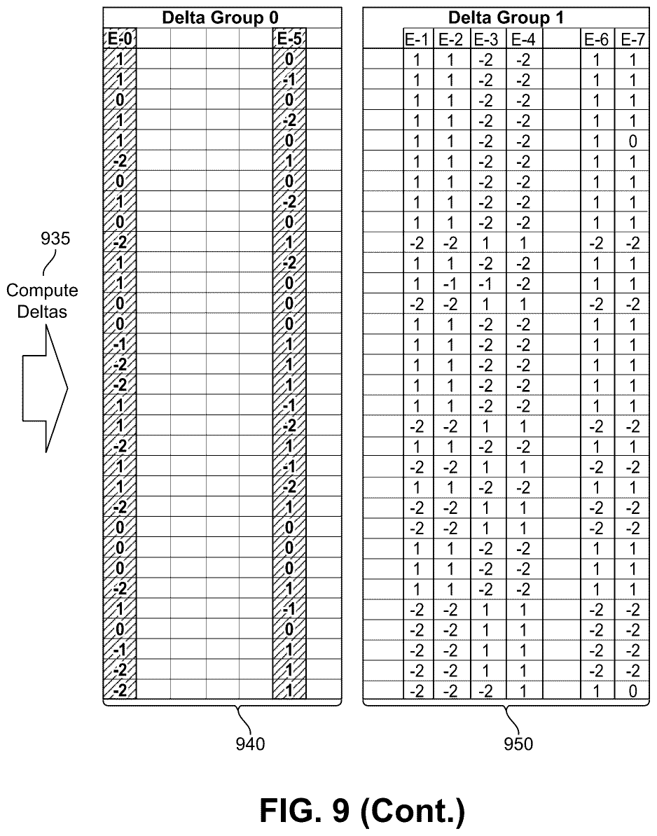

After the one or more processors has performed the clustering, the one or more processors can adjust the base values according to the number of bits (d). FIGS. 8 and 9 together show an example of adjusting the base values. In particular, FIG. 8 is a diagram illustrating tables 810, 820, 830, 840, 850 showing an example 800 of adjusting the base values according to the bit widths for the delta values. FIG. 9 is a diagram illustrating tables 910, 920, 930, 940, 950 showing a continuation 900 of the example 800 of FIG. 8 of adjusting base values according to bit widths for the delta values.

In one or more examples, to adjust the base values, the one or more processors can determine a range (e.g., [min: max]) for each of the clusters. The table 810 (e.g., a cluster ranges table) shows the cluster ranges for the clusters. In FIG. 8, the table 810 (e.g., a cluster ranges table) shows cluster ranges for each of the clusters in table 730 (e.g., a cluster table). For example, the range of the values (e.g., −61, −62) in the first row of the table 730 for the first cluster of expert models can be determined to be [−62:−61], which is shown in the first row, first column of the table 810.

After the cluster ranges have been determined, the one or more processors can determine the means (m) of the cluster ranges. The table 820 (e.g., a means table) shows the computed means for the cluster ranges. For example, the means of the values (e.g., [−62:−61]) in the first row, first column of the table 810 for the first cluster of expert models can be computed to be equal to −61.5, which is shown in the first row, first column of the table 820.

After the means of the cluster ranges has been computed, the one or more processors can round 825 the means values (e.g., x=round (m)). The table 830 (e.g., a rounding table) shows the rounding for the means values. For example, the means value (e.g., −61.5) in the first row, first column of the table 820 for the first cluster of expert models can be rounded to be equal to −62, which is shown in the first row, first column of the table 830.

After the means values have been rounded, the one or more processors can compute coverage for the clusters of the expert models (e.g., x−2^{d-1}: x+2^{d-1}−1). The table 840 (e.g., a coverage table) shows the coverage for the clusters of the expert models. For example, the rounding value (x) (e.g., −62) in the first row, first column of the table 830 can be used to compute the coverage to be equal to [−64:−61], which is shown in the first row, first column of the table 840.

After the coverage has been computed, the one or more processors can compute a shift 845 to ensure that the entire range is covered (e.g., x−2^{d-1}−min: x+2^{d-1}−1−max). The table 850 (e.g., a shifting table) shows the shift of the coverage. For example, the rounding value (x) (e.g., −62) in the first row, first column of the table 830 and the min and max values (e.g., −62, −61) in the first row, first column of the table 810 can be used to compute the shift of the coverage to be equal to [−2:−0], which is shown in the first row, first column of the table 850.

After the shift of the coverage has been computed, the one or more processors can compute a displacement 915 for the shifted coverage (e.g., where y=0, when ab<0; y=a, when |a|<|b|; and y=b, otherwise). In FIG. 9, the table 910 (e.g., a shifting table) is the same as the table 850 (e.g., a shifting table) of FIG. 8. The table 920 (e.g., a displacement table) shows the displacement. For example, the values ([a:b]) (e.g., [−2:0]) in the first row, first column of the table 910 can be used to compute the displacement to be equal to 0, which is shown in the first row, first column of the table 920.

After the displacement is computed, the one or more processors can compute the base values of the base values 925 (e.g., x-y) for the representation for the expert models. The table 930 (e.g., a base table) shows the computed bases values. For example, the rounding value (x) (e.g., −62) in the first row, first column of the table 830 and the y value of 0 in the first row, first column of the table 920 can be used to compute the base value to be equal to −62, which is shown in the first row, first column of the table 930.

After the base values have been computed, the one or more processors can compute the delta values 935 (e.g., expert model weight in clustering minus base value). The tables 940, 950 (e.g., delta map tables) show the computed delta values for the representation for the expert models. For example, the weight (e.g., −61) in the first row, first column of the table 730 and the base value (e.g., −62) in the first row, first column of the table 930 can be used to compute the delta value to be equal to 1, which is shown in the first row, first column of the table 940.

After the delta values have been computed, the one or more processors may clamp any of the delta values that exceed an upper threshold clamping value (e.g., the upper threshold clamping value may be equal to 2) to that upper threshold clamping value (e.g., 2). The one or more processors can also clamp any of the delta values that are below a lower threshold clamping value (e.g., the lower threshold clamping value may be equal to −2) to that lower threshold clamping value (e.g., −2). For example, as shown in the tables 940, 950, the delta values have been clamped such that they are all less than or equal to 2, and greater than equal to −2.

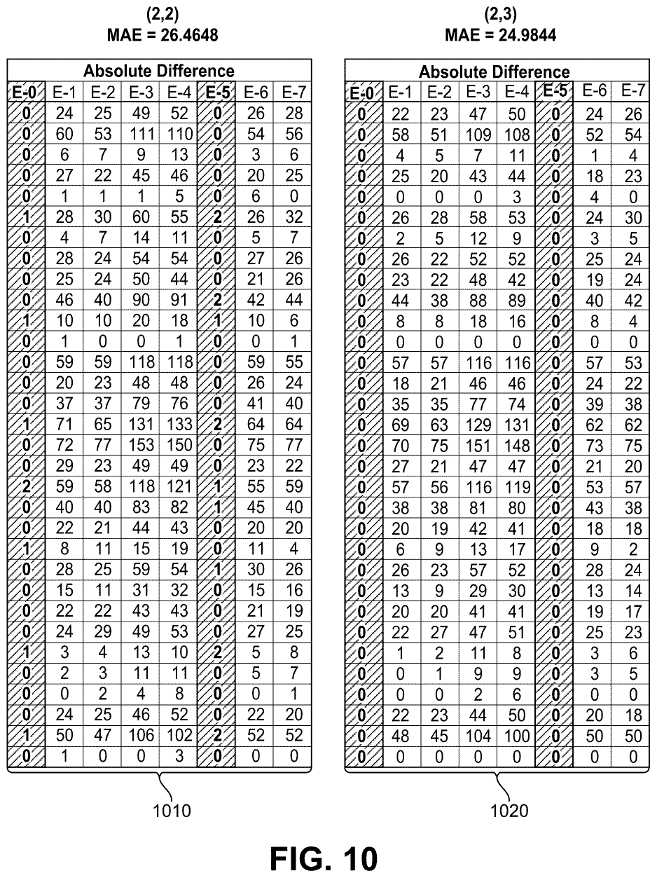

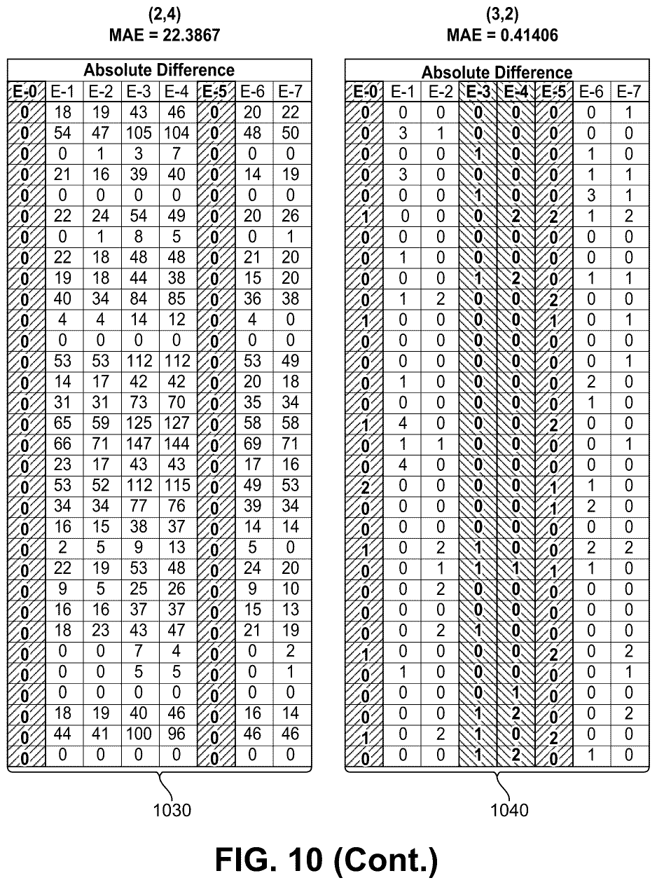

After the delta values have been computed and the clamping has been performed, the one or more processors can compute an absolute difference to determine any errors introduced by the clamping (e.g., an absolute value of the difference between the delta values prior to clamping and the delta values post clamping) for each of the candidate expert model groupings, including the (2, 3) pair. FIG. 10 is a diagram illustrating tables 1010, 1020, 1030, 1040 showing an example of selecting a candidate expert model grouping (e.g., (3, 2) pair) from a plurality of candidate expert model groupings (e.g., (2, 2) pair, (2, 3) pair, (2, 4) pair, and (3, 2) pair), based on representation errors for the plurality of the candidate expert model groupings. The tables 1010, 1020, 1030, 1040 of FIG. 10 show the absolute difference between the delta values prior to clamping and the delta values post clamping for the (2, 2) pair, (2, 3) pair, (2, 4) pair, and (3, 2) pair, respectively.

After the absolute differences has been computed, the one or more processors can compute a representation error of the absolute differences for each of the candidate expert model groupings, including the (2, 3) pair. In one or more examples, the representation error can be the mean absolute error (MAE).

After the representation errors have been computed for the candidate expert model groupings, the one or more processors can select, based on the candidate expert model grouping with the lowest representation error, a candidate expert model grouping of the candidate expert model groupings to be used for the machine learning processing. For example, in FIG. 10, the candidate expert model grouping corresponding to the (3, 2) pair is shown to have the lowest representation error (e.g., a MAE=0.41406) with respect to the other candidate expert model groupings. As such, the candidate expert model grouping corresponding to the (3, 2) pair can be selected to be used for the machine learning processing.

After the candidate expert model grouping has been selected, the one or more processors can store the corresponding base values and delta values for the selected candidate expert model grouping in storage (e.g., the storage 516 of FIG. 5).

In one or more aspects, machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others. Different types of neural networks exist, such as convolutional neural networks (CNNs), recurrent neural networks (RNNs), generative adversarial networks (GANs), multilayer perceptron (MLP) neural networks, transformer neural networks, among others.

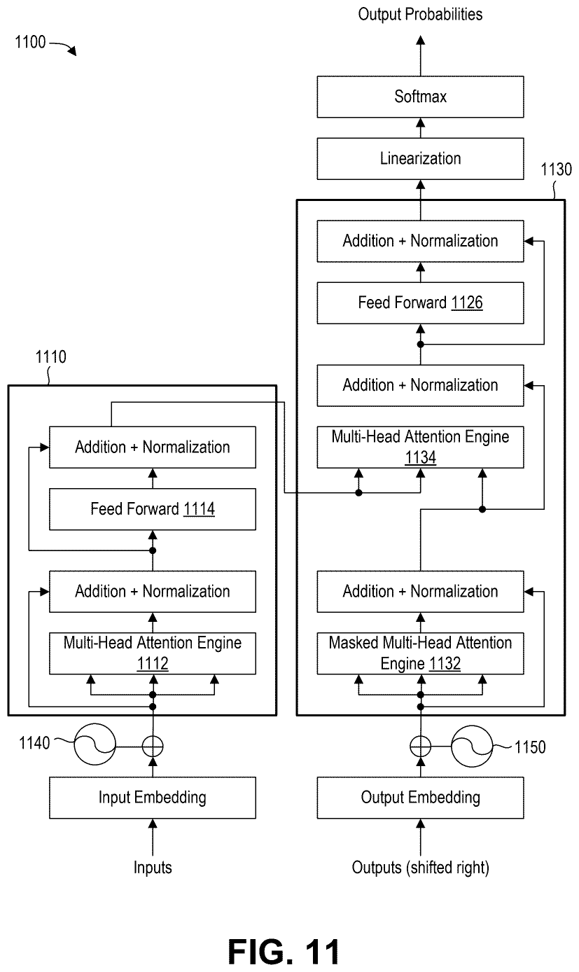

As described herein, an MOE model can utilize one or more transformers (e.g., a transformer block can include a set of expert feedforward network (FFN) layers). FIG. 11 is a block diagram of an example transformer. In a convolutional neural network (CNN) model, the number of operations required to relate signals from two arbitrary input or output positions grows in the distance between positions, which makes learning dependencies at different distant positions challenging for a CNN model. A transformer 1100 reduces the operations of learning dependencies by using an encoder 1110 and a decoder 1130 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1110 is composed of a stack of six identical layers and each layer has two sub-layers. The first sub-layer is a multi-head self-attention engine 1112, and the second sub-layer is a fully connected feed-forward network 1114. A residual connection (not shown) connects around each of the sub-layers followed by normalization.

In the example transformer 1100, the decoder 1130 is also composed of a stack of six (6) identical layers. The decoder also includes a masked multi-head self-attention engine 1132, a multi-head attention engine 1134 over the output of the encoder 1110, and a fully connected feed-forward network 1126. Each layer includes a residual connection (not shown) around the layer, which is followed by layer normalization. The masked multi-head self-attention engine 1132 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1140 to encode positions because the model does not contain recurrence and convolution and relative or absolute position of the tokens is needed. In the transformer 1100, the positional encodings are added to the input embeddings at the bottom layer of the encoder 1110 and the decoder 1130. The positional encodings are summed with the embeddings because the positional encodings and embeddings have the same dimensions. A corresponding position decoder 1150 is configured to decode the positions of the embeddings for the decoder 1130.

In some aspects, the transformer 1100 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1100 can process input sequences of variable length, making it well-suited for natural language processing tasks where input lengths can vary greatly. Additionally, the self-attention mechanism allows the transformer 1100 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

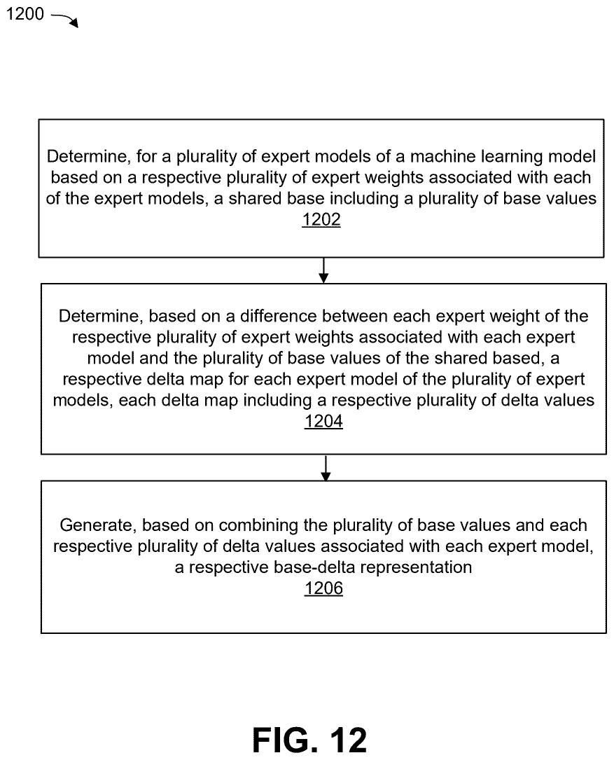

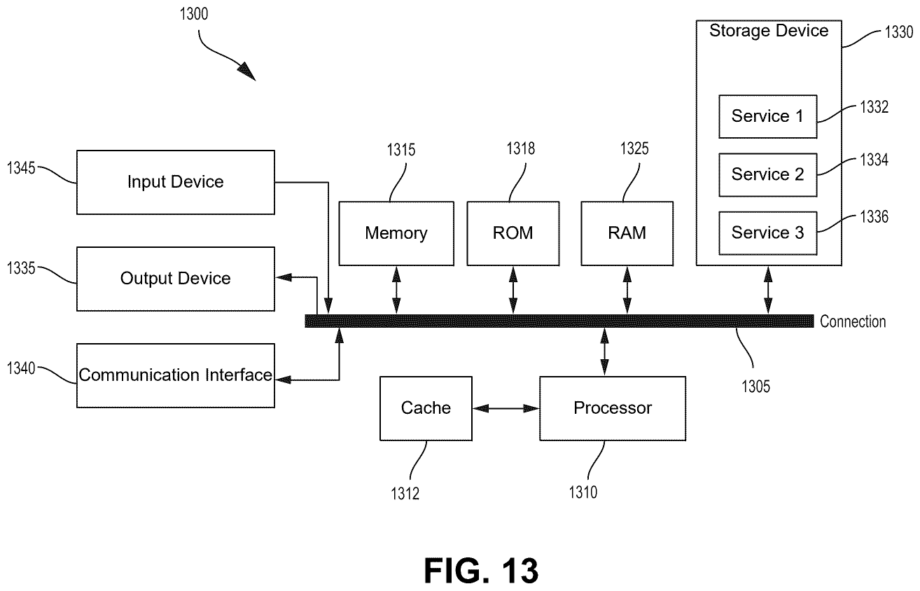

FIG. 12 is a flow chart illustrating an example of a process 1200 for enhancing ensemble learning models using base-delta coding. In some examples, the process 1200 may be performed by a computing device or apparatus or a component or system (e.g., the sparse model 115 of FIG. 1, the transformer 1100 of FIG. 11, one or more chipsets, one or more processors such as one or more CPUs, DSPs, NPUs, NSPs, microcontrollers, ASICS, FPGAs, programmable logic devices, discrete gates or transistor logic components, discrete hardware components, etc., an ML system such as a neural network model, any combination thereof, and/or other component or system) of the computing device or apparatus. In some examples, the computing system 1300 of FIG. 13 can perform the process 1200 of FIG. 12. The computing device or apparatus may be a vehicle or component or system of a vehicle, a mobile device (e.g., a mobile phone), a network-connected wearable such as a watch, an extended reality (XR) device (e.g., a virtual reality (VR) device, augmented reality (AR) device, and/or mixed reality (MR) device), or other type of computing device. In some cases, the computing device or apparatus can be a system on a chip (SOC), the computing system 1300 of FIG. 13, and/or other computing device or apparatus.

At block 1202, the computing device (or component thereof) can determine, for a plurality of expert models of a machine learning model based on a respective plurality of expert weights associated with each of the plurality of expert models, a shared base including a plurality of base values (e.g., the base 420 including the values 425). In some aspects, the computing device (or component thereof) can generate, based on training the machine learning model, the respective plurality of expert weights associated with each expert model of the plurality of expert models. In some examples, the machine learning model is an ensemble learning model. In some aspects, the computing device (or component thereof) can determine the shared base further based on clustering the plurality of expert models into a plurality of clusters (e.g., as discussed with respect to FIG. 7). Each cluster of the plurality of clusters includes a respective portion of expert models of the plurality of expert models (e.g., the first cluster of FIG. 7 including expert models E-0 to E-3 and the second cluster of FIG. 7 including expert models E-4 to E-7). In some cases, the clustering is performed based on a k-means clustering.

At block 1204, the computing device (or component thereof) can determine, based on a difference between each expert weight of the respective plurality of expert weights associated with each expert model and the plurality of base values of the shared base, a respective delta map for each expert model of the plurality of expert models. Each delta map includes a respective plurality of delta values.

At block 1206, the computing device (or component thereof) can generate, based on combining the plurality of base values and the respective plurality of delta values associated with each expert model, a respective base-delta representation.

In some aspects, the computing device (or component thereof) can clamp, based on a clamping threshold value, the respective plurality of delta values of the respective delta map determined for each expert model of the plurality of expert models. For instance, after the delta values are computed, the computing device (or component thereof) can clamp any of the delta values that exceed an upper threshold clamping value (e.g., the upper threshold clamping value may be equal to 2) to that upper threshold clamping value (e.g., 2) and/or can clamp any of the delta values that are below a lower threshold clamping value (e.g., the lower threshold clamping value may be equal to −2) to that lower threshold clamping value (e.g., −2). In some examples, as shown in the tables 940, 950, the delta values have been clamped such that they are all less than or equal to 2, and greater than equal to −2. In some aspects, the computing device (or component thereof) can generate, based on a bit width for each delta value of the respective plurality of delta values, a list of a plurality of candidate expert model groupings including the plurality of expert models (e.g., as discussed with respect to FIG. 8 and FIG. 9).

In some aspects, the computing device (or component thereof) can select, based on a respective representation error associated with each of the candidate expert model groupings, a candidate expert model grouping of the candidate expert model groupings for the machine-learning processing. In some cases, the respective representation error associated with each of the candidate expert model groupings is a mean absolute error.

In some cases, the computing device of process 1200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1200 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a block diagram illustrating an example of a computing system 1300, which may be employed for enhancing ensemble learning models using base-delta coding. In particular, FIG. 13 illustrates an example of computing system 1300, which can be for example any computing device making up internal computing system, a remote computing system, a camera, or any component thereof in which the components of the system are in communication with each other using connection 1305. Connection 1305 can be a physical connection using a bus, or a direct connection into processor 1310, such as in a chipset architecture. Connection 1305 can also be a virtual connection, networked connection, or logical connection.

In some aspects, computing system 1300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 can include a cache 1312 of high-speed memory connected directly with, in close proximity to, or integrated as part of processor 1310.

Processor 1310 can include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms. In some instances, multimodal systems can enable a user to provide multiple types of input/output to communicate with computing system 1300.

Computing system 1300 can include communications interface 1340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1340 may also include one or more range sensors (e.g., LiDAR sensors, laser range finders, RF radars, ultrasonic sensors, and infrared (IR) sensors) configured to collect data and provide measurements to processor 1310, whereby processor 1310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1340 may also include one or more receivers or transceivers that are used to determine a location of the computing system 1300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 can include software services, servers, services, etc., that when the code that defines such software is executed by the processor 1310, it causes the system to perform a function. In some aspects, a hardware service that performs a particular function can include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for machine-learning processing, comprising: at least one memory; and at least one processor coupled to at least one memory and configured to: determine, for a plurality of expert models of a machine learning model based on a respective plurality of expert weights associated with each of the plurality of expert models, a shared base comprising a plurality of base values; determine, based on a difference between each expert weight of the respective plurality of expert weights associated with each expert model and the plurality of base values of the shared base, a respective delta map for each expert model of the plurality of expert models, each delta map comprising a respective plurality of delta values; and generate, based on combining the plurality of base values and the respective plurality of delta values associated with each expert model, a respective base-delta representation.

Aspect 2. The apparatus of Aspect 1, wherein the at least one processor is configured to determine the shared base further based on clustering the plurality of expert models into a plurality of clusters, wherein each cluster of the plurality of clusters comprises a respective portion of expert models of the plurality of expert models.

Aspect 3. The apparatus of Aspect 2, wherein the clustering is performed based on a k-means clustering.

Aspect 4. The apparatus of any of Aspects 1 to 3, wherein the at least one processor is configured to clamp, based on a clamping threshold value, the respective plurality of delta values of the respective delta map determined for each expert model of the plurality of expert models.

Aspect 5. The apparatus of any of Aspects 1 to 4, wherein the at least one processor is configured to generate, based on a bit width for each delta value of the respective plurality of delta values, a list of a plurality of candidate expert model groupings comprising the plurality of expert models.

Aspect 6. The apparatus of Aspect 5, wherein the at least one processor is configured to select, based on a respective representation error associated with each of the candidate expert model groupings, a candidate expert model grouping of the candidate expert model groupings for the machine-learning processing.

Aspect 7. The apparatus of Aspect 6, wherein the respective representation error associated with each of the candidate expert model groupings is a mean absolute error.

Aspect 8. The apparatus of any of Aspects 1 to 7, wherein the at least one processor is configured to generate, based on training the machine learning model, the respective plurality of expert weights associated with each expert model of the plurality of expert models.

Aspect 9. The apparatus of Aspect 8, wherein the machine learning model is an ensemble learning model.

Aspect 10. A method for machine-learning processing, the method comprising: determining, for a plurality of expert models of a machine learning model based on a respective plurality of expert weights associated with each of the plurality of expert models, a shared base comprising a plurality of base values; determining, based on a difference between each expert weight of the respective plurality of expert weights associated with each expert model and the plurality of base values of the shared base, a respective delta map for each expert model of the plurality of expert models, each delta map comprising a respective plurality of delta values; and generating, based on combining the plurality of base values and the respective plurality of delta values associated with each expert model, a respective base-delta representation.

Aspect 11. The method of Aspect 10, wherein determining the shared base is further based on clustering the plurality of expert models into a plurality of clusters, wherein each cluster of the plurality of clusters comprises a respective portion of expert models of the plurality of expert models.

Aspect 12. The method of Aspect 11, wherein the clustering is performed based on a k-means clustering.

Aspect 13. The method of any of Aspects 10 to 12, further comprising clamping, based on a clamping threshold value, the respective plurality of delta values of the respective delta map determined for each expert model of the plurality of expert models.

Aspect 14. The method of any of Aspects 10 to 13, further comprising generating, based on a bit width for each delta value of the respective plurality of delta values, a list of a plurality of candidate expert model groupings comprising the plurality of expert models.

Aspect 15. The method of Aspect 14, further comprising selecting, based on a respective representation error associated with each of the candidate expert model groupings, a candidate expert model grouping of the candidate expert model groupings for the machine-learning processing.

Aspect 16. The method of Aspect 15, wherein the respective representation error associated with each of the candidate expert model groupings is a mean absolute error.

Aspect 17. The method of any of Aspects 10 to 16, further comprising generating, based on training the machine learning model, the respective plurality of expert weights associated with each expert model of the plurality of expert models.

Aspect 18. The method of Aspect 17, wherein the machine learning model is an ensemble learning model.

Aspect 19. A non-transitory computer-readable medium having stored thereon instructions that, when executed by at least one processor, cause the at least one processor to perform operations according to any of Aspects 10 to 18.

Aspect 20. An apparatus for machine-learning processing, the apparatus including one or more means for performing operations according to any of Aspects 10 to 18.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for machine-learning processing, comprising:
at least one memory; and
at least one processor coupled to at least one memory and configured to:
determine, for a plurality of expert models of a machine learning model based on a respective plurality of expert weights associated with each of the plurality of expert models, a shared base comprising a plurality of base values;
determine, based on a difference between each expert weight of the respective plurality of expert weights associated with each expert model and the plurality of base values of the shared base, a respective delta map for each expert model of the plurality of expert models, each delta map comprising a respective plurality of delta values; and
generate, based on combining the plurality of base values and the respective plurality of delta values associated with each expert model, a respective base-delta representation.

2. The apparatus of claim 1, wherein the at least one processor is configured to determine the shared base further based on clustering the plurality of expert models into a plurality of clusters, wherein each cluster of the plurality of clusters comprises a respective portion of expert models of the plurality of expert models.

3. The apparatus of claim 2, wherein the clustering is performed based on a k-means clustering.

4. The apparatus of claim 1, wherein the at least one processor is configured to clamp, based on a clamping threshold value, the respective plurality of delta values of the respective delta map determined for each expert model of the plurality of expert models.

5. The apparatus of claim 1, wherein the at least one processor is configured to generate, based on a bit width for each delta value of the respective plurality of delta values, a list of a plurality of candidate expert model groupings comprising the plurality of expert models.

6. The apparatus of claim 5, wherein the at least one processor is configured to select, based on a respective representation error associated with each of the candidate expert model groupings, a candidate expert model grouping of the candidate expert model groupings for the machine-learning processing.

7. The apparatus of claim 6, wherein the respective representation error associated with each of the candidate expert model groupings is a mean absolute error.

8. The apparatus of claim 1, wherein the at least one processor is configured to generate, based on training the machine learning model, the respective plurality of expert weights associated with each expert model of the plurality of expert models.

9. The apparatus of claim 8, wherein the machine learning model is an ensemble learning model.

10. A method for machine-learning processing, the method comprising:
determining, for a plurality of expert models of a machine learning model based on a respective plurality of expert weights associated with each of the plurality of expert models, a shared base comprising a plurality of base values;
determining, based on a difference between each expert weight of the respective plurality of expert weights associated with each expert model and the plurality of base values of the shared base, a respective delta map for each expert model of the plurality of expert models, each delta map comprising a respective plurality of delta values; and
generating, based on combining the plurality of base values and the respective plurality of delta values associated with each expert model, a respective base-delta representation.

11. The method of claim 10, wherein determining the shared base is further based on clustering the plurality of expert models into a plurality of clusters, wherein each cluster of the plurality of clusters comprises a respective portion of expert models of the plurality of expert models.

12. The method of claim 11, wherein the clustering is performed based on a k-means clustering.

13. The method of claim 10, further comprising clamping, based on a clamping threshold value, the respective plurality of delta values of the respective delta map determined for each expert model of the plurality of expert models.

14. The method of claim 10, further comprising generating, based on a bit width for each delta value of the respective plurality of delta values, a list of a plurality of candidate expert model groupings comprising the plurality of expert models.

15. The method of claim 14, further comprising selecting, based on a respective representation error associated with each of the candidate expert model groupings, a candidate expert model grouping of the candidate expert model groupings for the machine-learning processing.

16. The method of claim 15, wherein the respective representation error associated with each of the candidate expert model groupings is a mean absolute error.

17. The method of claim 10, further comprising generating, based on training the machine learning model, the respective plurality of expert weights associated with each expert model of the plurality of expert models.

18. The method of claim 17, wherein the machine learning model is an ensemble learning model.

19. A non-transitory computer-readable medium having stored thereon instructions that, when executed by at least one processor, cause the at least one processor to:
determine, for a plurality of expert models of a machine learning model based on a respective plurality of expert weights associated with each of the plurality of expert models, a shared base comprising a plurality of base values;
determine, based on a difference between each expert weight of the respective plurality of expert weights associated with each expert model and the plurality of base values of the shared base, a respective delta map for each expert model of the plurality of expert models, each delta map comprising a respective plurality of delta values; and
generate, based on combining the plurality of base values and the respective plurality of delta values associated with each expert model, a respective base-delta representation.

20. The non-transitory computer-readable medium of claim 19, wherein the shared base is determined further based on clustering the plurality of expert models into a plurality of clusters, wherein each cluster of the plurality of clusters comprises a respective portion of expert models of the plurality of expert models.
